(19) United States
(12) Patent Application Publication
(10) Pub. No.: US 2015/0294041 A1
(43) Pub. Date: Oct. 15, 2015

(54) METHODS, SYSTEMS, AND COMPUTER READABLE MEDIA FOR SIMULATING SOUND PROPAGATION USING WAVE-RAY COUPLING

(71) Applicant: The University of North Carolina at Chapel Hill, Chapel Hill, NC (US)

(72) Inventors: Hengchin Yeh, Chapel Hill, NC (US); Ravish Mehra, Chapel Hill, NC (US); Lakulish Shailesh Antani, Chapel Hill, NC (US); Zhimin Ren, San Francisco, CA (US); Ming Lin, Chapel Hill, NC (US); Dinesh Manocha, Chapel Hill, NC (US)

(21) Appl. No.: 14/329,251

(22) Filed: Jul. 11, 2014

Related U.S. Application Data
(60) Provisional application No. 61/845,357, filed on Jul. 11, 2013.

(51) Int. Cl. G06F 17/50; G06F 17/10

(52) U.S. Cl. CPC G06F 17/5009; G06F 17/10

(57) ABSTRACT

Methods, systems, and computer readable media for simulating sound propagation are disclosed. According to one exemplary method, the method includes decomposing a scene having at least one object into at least one near-object region and at least one far-object region. The method also includes generating at least one transfer function for the at least one near-object region, wherein the at least one transfer function maps an incoming sound field reaching the at least one object to an outgoing sound field emanating from the at least one object, wherein the incoming sound field is based on a geometric acoustic technique and the outgoing sound field is based on a numerical acoustic technique. The method further includes utilizing the at least one transfer function to perform simulation of sound propagation within the scene.

### PRIORITY CLAIM

This application claims the benefit of U.S. Provisional Patent Application Ser. No. 61/845,357, filed Jul. 11, 2013; the disclosure of which is incorporated herein by reference in its entirety.

### TECHNICAL FIELD

The subject matter described herein relates to sound propagation. More specifically, the subject matter relates to methods, systems, and computer readable media for simulating sound propagation using wave-ray coupling.

### BACKGROUND

Sound propagation techniques determine how sound waves travel in a space and interact with the environment. In many applications, it is important to be able to simulate sound propagation in large scenes, such as games and training in both indoor and outdoor scenes, noise prediction in urban areas, and architectural acoustics design for buildings and interior spaces such as concert halls. Realistic acoustic effects can also improve the realism of a virtual environment. Acoustic phenomena such as interference, diffraction, and scattering for general scenes can only be captured by accurately solving the acoustic wave equation. The large spatial and frequency domain and accuracy requirement pose a dual challenge for acoustic techniques to be used in these diverse domains with different requirements.

Various techniques may be used in predicting or simulating sound propagation. Some techniques may involve assuming sound travels like rays (e.g., like beams of lights). Other techniques may involve assuming sound travels like waves. Both types of techniques have advantages and disadvantages.

Accordingly, there exists a need for methods, systems, and computer readable media for simulating sound propagation using wave-ray coupling.

### SUMMARY

Methods, systems, and computer readable media for simulating sound propagation are disclosed. According to one exemplary method, the method includes decomposing a scene having at least one object into at least one near-object region and at least one far-object region. The method also includes generating at least one transfer function for the at least one near-object region, wherein the at least one transfer function maps an incoming sound field reaching the at least one object to an outgoing sound field emanating from the at least one object, wherein the incoming sound field is based on a geometric acoustic technique and the outgoing sound field is based on a numerical acoustic technique. The method further includes utilizing the at least one transfer function to perform simulation of sound propagation within the scene.

A system for simulating sound propagation is also disclosed. The system includes a processor and a sound propagation model (SPM) module executable by the processor. The SPM module is configured to decompose a scene having at least one object into at least one near-object region and at least one far-object region; to generate at least one transfer function for the at least one near-object region, wherein the at least one transfer function maps an incoming sound field reaching the at least one object to an outgoing sound field emanating from the at least one object, wherein the incoming sound field is based on a geometric acoustic technique and the outgoing sound field is based on a numerical acoustic technique; and to utilize the at least one transfer function to perform simulation of sound propagation within the scene.

The subject matter described herein can be implemented in software in combination with hardware and/or firmware. For example, the subject matter described herein can be implemented in software executed by a processor. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, the term “node” refers to a physical computing platform or device including one or more processors and memory.

As used herein, the term “module” refers to hardware, firmware, or software in combination with hardware and/or firmware for implementing features described herein.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a diagram illustrating an exemplary node for simulating sound propagation according to an embodiment of the subject matter described herein;

FIG. 2 is a diagram illustrating an exemplary process for simulating propagated sound using a hybrid sound propagation technique according to an embodiment of the subject matter described herein;

FIG. 3 is a diagram indicating spatial decomposition techniques for various scenarios according to an embodiment of the subject matter described herein;

FIG. 4 is a diagram illustrating two-way coupling of pressure values computed by geometric and numerical techniques according to an embodiment of the subject matter described herein;

FIG. 5 is a diagram illustrating total pressure fields computed by an exemplary hybrid technique described herein and a boundary element method (BEM);

FIG. 6 includes a graph illustrating errors associated with order of reflections modeled;

FIG. 7 includes a graph illustrating precomputation time associated with terrains of different volumes; and

FIG. 8 is a diagram illustrating an exemplary process for simulating sound propagation according to an embodiment of the subject matter described herein.

### DETAILED DESCRIPTION

The subject matter described herein discloses methods, systems, and computer readable media for simulating sound propagation using wave-ray coupling.

### 1. Introduction

Sound propagation techniques are used to model how sound waves travel in the space and interact with various objects in the environment. Sound propagation algorithms are used in many interactive applications, such as computer games or virtual environments, and offline applications, such as noise prediction in urban scenes, architectural acoustics, virtual prototyping, etc. Realistic sound propagation that can model different acoustic effects, including diffraction, interference, scattering, and late reverberation, can considerably improve a user's immersion in an interactive system and provides spatial localization [6].

The acoustic effects can be accurately simulated by numerically solving the acoustic wave equation. Some of the well-known solvers are based on the boundary-element method, the finite element method, the finite-difference time-domain method, etc. However, the time and space complexity of these solvers increases linearly with the volume of the acoustic space and is a cubic (or higher) function of the source frequency. As a result, these techniques are limited to interactive sound propagation at low frequencies (e.g. 1-2 KHz) [24; 19], and may not scale to large environments.

Many interactive applications use geometric sound propagation techniques, which assume that sound waves travels like rays. This is a valid assumption when the sound wave travels in free space or when the size of intersecting objects is much larger than the wavelength. As a result, these geometric techniques are unable to simulate many acoustic effects at low frequencies, including diffraction, interference, and higher-order wave effects. Many hybrid combinations of numeric and geometric techniques have been proposed, but they are limited to small scenes or offline applications.

In accordance with some aspects of the present subject matter described herein, a hybrid technique may be provided or supported (e.g., by a computing platform or module) that couples geometric and numerical acoustic techniques for performing interactive and accurate sound propagation in complex scenes. For example, a sound propagation modeling or simulation application in accordance with some aspects of the present subject matter described herein may use a combination of spatial decomposition and frequency decomposition, along with a novel two-way wave-ray coupling algorithm. In this example, the entire simulation domain may be decomposed into different regions, and the sound field may be computed separately by geometric and numerical techniques for each region. Continuing with this example, in the vicinity of objects whose sizes are comparable to the simulated wavelength (near-object regions), numerical wave-based methods may be utilized to simulate all wave effects. In regions away from objects (far-field regions), including the free space and regions containing objects that are much larger than the wavelength, a geometric ray tracing algorithm may be used to model sound propagation. In some embodiments, numeric propagation techniques may be restricted to small regions of the environment and precompute the pressure field at low frequencies. In such embodiments, the rest of the pressure field may be precomputed using ray tracing.

In accordance with some aspects of the present subject matter described herein, a two-coupling procedure may be provided or supported (e.g., by a computing platform or module) for coupling pressures computed by two different acoustic techniques. For example, at an interface between near-object and far-field regions, pressures computed by two different (one numerical and one geometric) acoustic techniques may need to be coupled. In this example, rays entering a near object region may define the incident pressure field that serves as the input to the numerical acoustic solver. Continuing with this example, a numerical solver may compute the outgoing scattered pressure field, which in turn may be represented by rays exiting the near-object region. In some embodiments, two-way coupling may be represented using transfer functions described herein, where the transfer function may compute or allow modeling of multiple (e.g., all) orders of interaction.

In accordance with some aspects of the present subject matter described herein, an efficient hybrid approach may be provided or supported (e.g., by a computing platform or module) that decomposes the scene into regions that are more suitable for either geometric or numerical acoustic techniques, exploiting the strengths of both.

In accordance with some aspects of the present subject matter described herein, novel two-way coupling between wave-based and ray-based acoustic simulation based on fundamental solutions at the interface that ensures the consistency and validity of the solution given by the two methods is supported or provided (e.g., by a computing platform or module).

In accordance with some aspects of the present subject matter described herein, a real-time and/or memory efficient sound rendering system may use some aspects described herein to provide realistic acoustic effects. For example, an interactive audio rendering system may use an exemplary hybrid sound propagation technique that requires significantly less resources (e.g., memory) than conventional sound propagation techniques. In this example, the rendering system may perform pressure evaluation that requires orders of magnitude less memory compared to state-of-the-art wave equation solvers.

### 2 Related Work

In this section, a brief overview of related work on sound propagation and reverberation is disclosed.

### 2.1 Numerical Acoustic Techniques

Accurate, numerical acoustic simulations typically solve the acoustic wave equation using numerical methods, such as finite differences [7], finite elements [26], boundary elements [11], or adaptive rectangular decomposition [23]. However, their time and space complexity increases as a third or fourth power of frequencies. Despite recent advances, they remain impractical for many large scenes.

The equivalent source [21], expresses the solution fields of the wave equation in terms of a linear combination of points sources of various order (monopoles, dipoles, etc.). James et al. [14] solved a related sound radiation problem, using equivalent sources to represent the radiation field generated by a vibrating object.

### 2.2 Geometric Acoustic Techniques

Most acoustics simulation software and commercial systems are based on geometric techniques [8; 32] that assume sound travels along linear rays [9]. The simplified assumption of rays limits these methods to accurately capture specular and diffuse reflections only at high frequencies. Diffraction is typically modeled by identifying individual diffracting edges [26; 30]. These ray-based techniques can interactively model early reflections and first order edge-diffraction [27]; however, they cannot interactively model the reverberation of the impulse response explicitly, since that would require high-order reflections and wave effects such as scattering, interference, and diffraction. While ray tracing has been successfully used in many interactive acoustics systems [17], the number of rays traced has to be limited for scenes with moving listeners in order to maintain real-time performance.

### 2.3 Hybrid Techniques

Several methods for combining geometric and numerical acoustic techniques have been proposed. One line of work is based on frequency decomposition: dividing the frequencies to be modeled into low and high frequencies. Low frequencies are modeled by numerical acoustic techniques, and high frequencies are treated by geometric methods, including the finite difference time domain method (FDTD) [25; 18], the digital waveguide mesh method (DWM) [20], and the finite element method (FEM) [10; 2]. However, these methods use numerical methods at lower frequencies over the entire domain. As a result, they are limited to offline applications and may not scale to very large scenes.

Another method of hybridization is based on spatial decomposition. The entire simulation domain is decomposed to different regions: near-object regions are handled by numerical acoustic techniques to simulate wave effects, while far-field regions are handled by geometric acoustic techniques. Hampel et al. [13] combine the boundary element method (BEM) and geometric acoustics using a spatial decomposition. Their method provides a one-way coupling from BEM to ray tracing, converting pressures in the near-object region (computed by BEM) to rays that enter the far-field region containing the listener. In electromagnetic wave propagation, Wang et al. [33] propose a hybrid technique combining ray tracing and FDTD. Their technique is also based on a one-way coupling, where rays are traced in the far-field region and collected at the boundaries of the near-object regions. The pressures are then evaluated and serve as the boundary condition for the FDTD method. These one-way coupling methods do not allow the rays to exit and reenter the near-object regions of an object, and therefore acoustic effects of that objection will not be propagated to the far-filed regions. Barbone et al. [4] propose a two-way coupling that combines the acoustic field generated using ray tracing and FEM. Jean et al. [15] present a hybrid BEM/beam tracing approach to compute the radiation of tyre noise. However, these methods do not describe how multiple entrance of rays into near-object regions of different objects is handled, which is crucial when simulating interaction between multiple objects.

### 2.4 Acoustic Kernel-Based Interactive Techniques

There has been work in enabling interactive auralization for acoustic simulations through precomputation. At a high level, these techniques tend to precompute an acoustic kernel, which is used at runtime for interactive propagation in static environments. Raghuvanshi et al. [24] precompute acoustic responses on a sampled spatial grid using a numerical solver. They then encode perceptually salient information to perform interactive sound rendering. Mehra et al. [19] proposed an interactive sound propagation technique for large outdoor scenes based on equivalent sources. Other techniques use geometric methods to precompute high-order reflections or reverberation [29; 1] and compactly store the results for interactive sound propagation at runtime.

In accordance with some aspects of the present subject matter described herein, an exemplary method or technique described herein can be integrated into any of these systems as an acoustic kernel that can efficiently capture wave effects in a large scene.

Reference will now be made in detail to exemplary embodiments of the subject matter described herein, examples of which are illustrated in the accompanying drawings. Wherever possible, the same reference numbers will be used throughout the drawings to refer to the same or like parts.

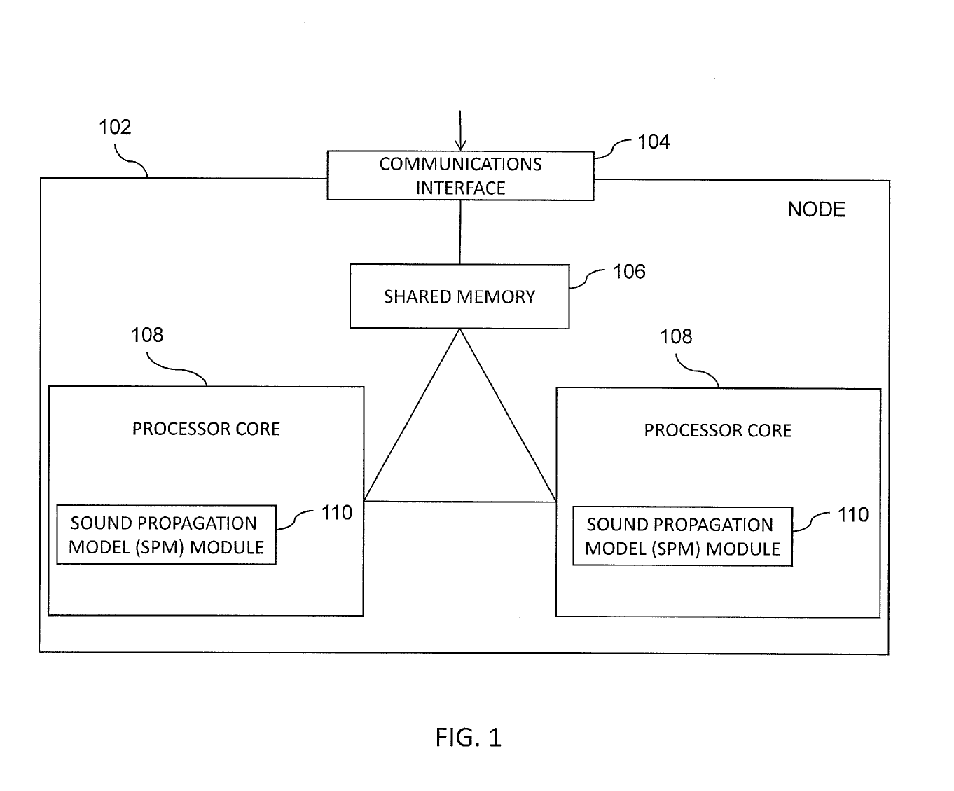

FIG. 1 is a diagram illustrating an exemplary node 102 (e.g., a single or multiple processing core computing device) for simulating sound propagation according to an embodiment of the subject matter described herein. Node 102 may be any suitable entity, such as a computing device or platform, for performing one more aspects of the present subject matter described herein or in a manuscript entitled “Sound Propagation in Large Complex Environment Using Wave-Ray Coupling;” the disclosure of the manuscript is incorporated herein by reference in its entirety. In accordance with some embodiments of the subject matter described herein, components, modules, and/or portions of node 102 may be implemented or distributed across multiple devices or computing platforms. For example, a cluster of nodes 102 may be used to perform various portions of a sound propagation technique or application.

Node 102 may include a communications interface 104, a shared memory 106, and one or more processor cores 108. Communications interface 104 may be any suitable entity (e.g., a communications interface) for receiving and/or sending messages. For example, communications interface 104 may be interface between various nodes 102 in a computing cluster. In another example, communications interface 104 may be associated with a user interface or other entity and may receive configuration setting and/or source data, such as audio information, for processing during a sound propagation model application.

In some embodiments, communications interface 104 or another component may be configured to identify or select a processor core 108 for processing or analysis and/or information for storage. For example, communications interface 104 may receive information from another node in a cluster and may determine that a particular processor core 108 should process the received information. In another example, communications interface 104 may store information in shared memory 106 and the stored information may be retrieved later by an available processor core 108.

Shared memory 106 may be any suitable entity (e.g., random access memory or flash memory) for storing sound propagation information, such as transfer functions, pressure field data, source audio information, and/or other information. Various components, such as communications interface 104 and software executing on processor cores 108, may access (e.g., read from and/or write to) shared memory 106.

Each of processor cores 108 represents any suitable entity (e.g., a physical processor, a field-programmable gateway array (FPGA), and/or an application-specific integrated circuit (ASIC)) for performing one or more functions associated with sound propagation modeling. Processing cores 108 may include or access memory, such as for storing executable instructions. Processor core 108 may be associated with a sound propagation model (SPM) module 110. SPM module 110 may be configured to use one or more techniques (e.g., geometric acoustic techniques and/or numerical acoustic techniques) for simulating sound propagation in one or more environments.

Geometric acoustic techniques typically solve the sound propagation problem by using assuming sound travels like rays. As such, geometric acoustic techniques may provide a good approximation of sound propagation when the sound wave travels in free space or when the interacting objects are large compared to the wavelength of sound. Therefore, these methods are more suitable for small wavelength (high frequency) sound waves, where the wave effect is not significant. However, for large wavelengths (low frequencies), it remains challenging to accurately model the diffraction and higher order wave effects. Despite these limitations, geometric acoustic techniques are popular due to their computational efficiency, which enable them to handle very large scenes. Exemplary geometric acoustic techniques that may be used by SPM 110 include methods based on stochastic ray tracing or image sources.

Numerical acoustic techniques directly solve the acoustic wave equation and are generally able to accurately capture wave phenomena such as interference, diffraction, scattering, and higher order effects that are a combination of these phenomena. However, numerical acoustic techniques are significantly more expensive (e.g., resource intensive). For a maximum simulated frequency, the simulation time typically scales as the fourth power and the memory is proportional to the total volume or surface area of the scene. Therefore, in general, it is highly challenging to numerically simulate or model sound propagation in a large domain up to a meaningful maximum frequency. Exemplary numerical acoustic techniques that may be used by SPM 110 include methods for solving the acoustic wave equation, such as a finite differences method, a finite elements method, a boundary elements method, an adaptive rectangular decomposition method, and an equivalent source method.

In accordance with some embodiments of the subject matter described herein, SPM module 110 may be configured to use or perform a hybrid technique (e.g., using two or more acoustic techniques) for simulating sound propagation. By using a hybrid technique, SPM module 110 may benefit from advantages associated with multiple sound propagation techniques while minimizing associated disadvantages. For example, if a scene or virtual environment includes a large amount of free space (e.g., open space or air) and one or two “small” (e.g., in relation to a sound's wavelength) objects, SPM 110 may use a geometric (e.g., a ray-based) acoustic technique to model or simulate sound propagation in the free space portion of the environment and may use a numerical (e.g., wave-based) acoustic technique to model sound propagation for areas near the two “small” objects. In this example, by applying the numerical acoustic technique only in limited, smaller regions, SPM 110 may utilize computational resources more efficiently, thereby reducing the total computation time.

In accordance with some embodiments of the subject matter described herein, SPM module 110 may be configured to perform two-way, wave-ray coupling at an interface between regions that use different acoustic techniques. For example, wave-ray coupling may be used where sound interacts between a region that uses a wave-based acoustic technique (e.g., numerical acoustic techniques) for simulating sound propagation and a region that uses a ray-based acoustic technique (e.g., a geometric acoustic technique) for simulating sound propagation. By allowing this interaction and using wave-ray coupling, sound propagation is more accurately simulated.

In accordance with some embodiments of the subject matter described herein, SPM module 110 may be configured to generate one or more transfer functions that represent two-way, wave-ray coupling and may generate the transfer function prior to simulating sound propagation for a scene or virtual environment.

In accordance with some embodiments of the subject matter described herein, SPM module 110 may be configured to work in parallel with a plurality of processor cores 108 and/or nodes 102. For example, a plurality of processor cores 108 may each be associated with a SPM module 110. In this example, each processor core 108 may perform processing associated with simulating sound propagation for a particular environment. In another example, some nodes 102 and/or processing cores 108 may be utilized for precomputing (e.g., performing decomposition of a spatial domain or scene and generating transfer functions) and other nodes 102 and/or processing cores 108 may be utilized during run-time, e.g., to execute a sound propagation model application that utilizes precomputed values or functions.

It will be appreciated that FIG. 1 is for illustrative purposes and that various nodes, their locations, and/or their functions may be changed, altered, added, or removed. For example, some nodes and/or functions may be combined into a single entity. In a second example, a node and/or function may be located at or implemented by two or more nodes.

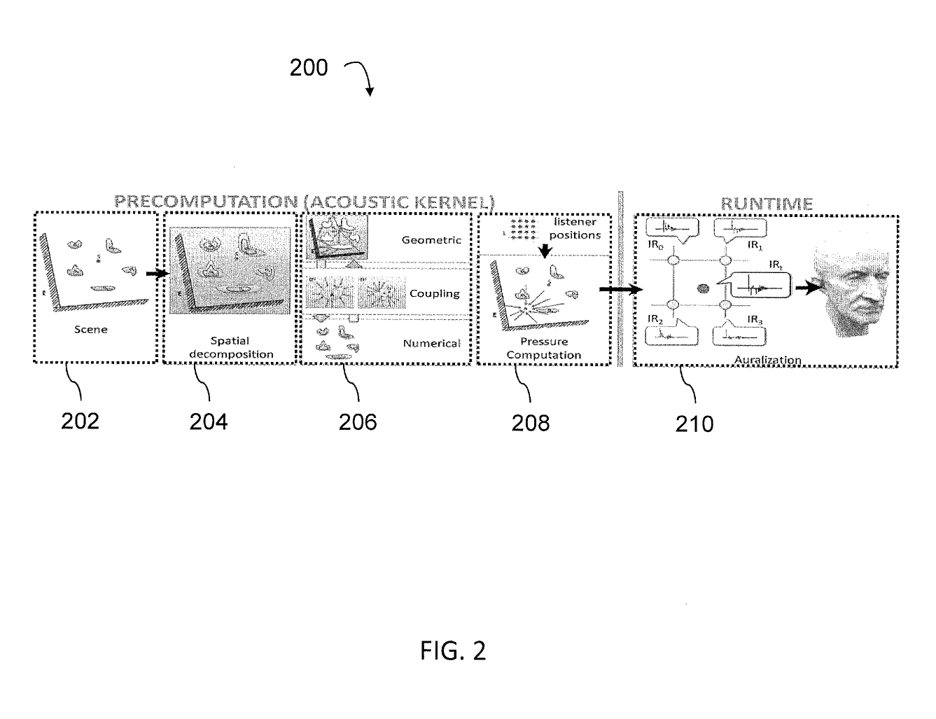

FIG. 2 is a diagram illustrating an exemplary process 200 for simulating propagated sound using a hybrid sound propagation technique according to an embodiment of the subject matter described herein.

Referring to process 200, at step 202, in a precomputation phase, a scene may be classified into objects and environment features. For example, classification may include near-object regions and far-field regions.

At step 204, spatial decomposition may be performed. For example, a sound field in near-object regions may be computed using a numerical wave simulation, while a sound field in far-field regions may be computed using geometric acoustic techniques.

At step 206, a two-way coupling procedure may be performed. For example, a two-way coupling procedure may couple the results computed by geometric and numerical methods.

At step 208, pressure computation for various listener positions may be performed. For example, sound pressures may be computed at different listener positions to generate impulse responses.

At step 210, sound may be rendered using one or more precomputed impulse responses. For example, at runtime, the precomputed impulse responses (IR₀-IR₃) are retrieved and interpolated for the specific listener position (IRₜ) at interactive rates, and final sound is rendered.

In some embodiments, exemplary process 200, a portion therein, and/or a related acoustic kernel may be integrated with Valve's Source™ game engine. Using this game engine, acoustic effects for a variety of scenarios are demonstrable. For example, the integrated game engine may demonstrate sound propagation for both large indoor and outdoor scenes (similar to geometric techniques) as well as generate realistic acoustic effects (similar to numeric wave solvers), including late reverberation, high-order reflections, reverberation coloration, sound focusing, and diffraction low-pass filtering around obstructions.

It will be appreciated that FIG. 2 is for illustrative purposes and that additional and/or different steps from ones described herein with regard to FIG. 2 may be used for simulating propagated sound.

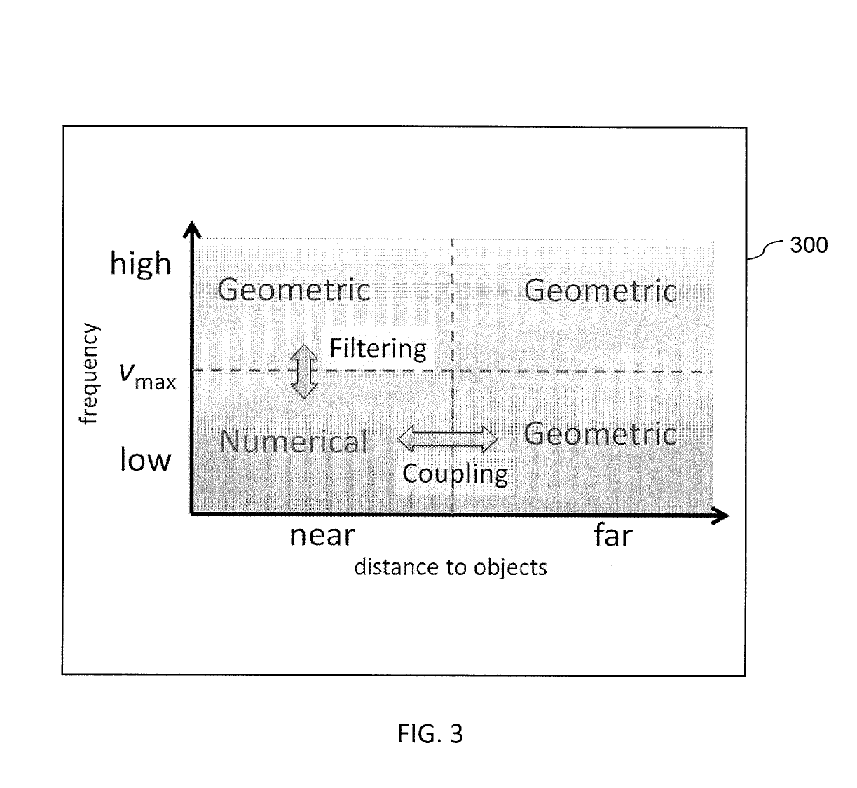

FIG. 3 is a diagram indicating spatial decomposition techniques for various scenarios according to an embodiment of the subject matter described herein. Referring to FIG. 3, quadrants are labeled to indicate preferred or effective spatial decomposition techniques with regard to frequency and distance to objects. FIG. 3 indicates that high frequencies may be simulated using geometric techniques, while low frequencies may be simulated using a combination of numerical and geometric techniques based on a spatial decomposition.

### 3 Overview

In this section, an overview of sound propagation and some aspects of the present subject matter herein are disclosed.

### 3.1 Sound Propagation

For a sound pressure wave with angular frequency ω, speed of sound c, the problem of sound propagation in domain Ω in the space can be expressed as a boundary value problem for the Helmholtz equation:

$${∇}^{2} p + \frac{{w}^{2}}{{c}^{2}} p = f ; \\ x ∈ Ω , \qquad ( 1 )$$

where p(x) is the complex valued pressure field, ∇² is the Laplacian operator, and f(x) is the source term, (e.g. =0 in free space and δ(\acute{x}) for a point source located at \acute{x}). Boundary conditions are specified on the boundary an of the domain (which can be the surface of a solid object, the interface between different media, or an arbitrarily defined surface) by a Dirichlet boundary condition that specifies pressure, p(x)=0; xε∂Ω, a Neumann boundary condition that specifies the velocity of medium,

$$\frac{\partial p ( x )}{\partial n} = 0 ;$$

xε∂Ω, or a mixed boundary condition that specifies a complex-valued constant Z, so that

$$Z \frac{\partial p ( x )}{\partial n} + p ( x ) = 0 ;$$

$$x ∈ \partial Ω .$$

The pressure p at infinity must also be specified, usually by the Sommerfeld radiation condition [22],

$${lim}_{‖ x ‖ \to ∞} [ \frac{\partial p}{\partial ‖ x ‖} + \hat{j} wcp ] = 0 ,$$

where ∥x∥ is the distance of point x from the origin and ĵ=\sqrt{−1}.

Different acoustic techniques aim to solve the above equations with different formulations. Numerical acoustic techniques discretize Equation (1) and solve for p numerically with boundary conditions. Geometric acoustic techniques model p as a discrete set of rays emitted from sound sources which interact with the environment and propagate the pressure.

### 3.2 Acoustic Transfer Function

When modeling the acoustic effects due to objects or surfaces in a scene, it is often useful to define the acoustic transfer function. Many different acoustic transfer functions have been proposed to simulate different acoustic effects. In sound propagation problems, the acoustic transfer function maps an incoming sound field to an outgoing sound field. For example, Waterman developed a transition-matrix method for acoustic scattering [34] and maps the incoming and outgoing fields in terms of the coefficients of a complete system of vector basis functions. Antani et al. [1] compute an acoustic radiance transfer operator that maps incident sound to diffusely reflected sound in a scene. Mehra et al. [19] model the free-field acoustic behavior of an object, as well as pairwise interactions between objects. In sound radiation problems, James et al. [14] map the vibration mode of an object to the radiated sound pressure field.

### 3.3 Hybrid Sound Propagation

In this section, various aspects associated with an exemplary hybrid sound propagation technique and/or system are disclosed. An exemplary technique described herein uses a combination of frequency decomposition and spatial decomposition, as shown schematically in FIG. 3. Since frequency decomposition is a standard technique [10], aspects described herein mostly focus on spatial decomposition and various embodiments of a novel two-way coupling algorithm (see FIG. 2).

Frequency Decomposition: We divide the modeled frequencies to low and high frequencies, with a crossover frequency vₘₐₓ. For high frequencies, geometric techniques are used throughout the entire domain. For low frequencies, a combination of numerical and geometric techniques is used based on a spatial decomposition described below. Typical values for vₘₐₓ are 0.5-2 kHz, and a simple low-pass-high-pass filter combination is usually used to join the results at the crossover frequency region.

Spatial decomposition: Given a scene we first classify it into small objects and environment features. The small objects, or simply objects, are of size comparable to or smaller than the wavelength of the sound pressure wave being simulated. The environment features represent objects much larger than the wavelength (like terrain). The wavelength that is used as the criterion for distinguishing small or large objects is a user-controlled parameter. One possible choice is the maximum audible wavelength (17 m), corresponding to the lowest audible frequency for human (20 Hz). When sound interacts with objects, wave phenomena are prominent only when the objects are small relative to the wavelength. Therefore we only need to compute accurate wave propagation in the local neighborhood of small objects. We call this neighborhood the near-object region (orange region in FIG. 2) of an object, and numerical acoustic techniques are used to compute the sound pressure field in this region. The region of space away from small objects is called the far-field region and is handled by geometric acoustic techniques (blue region in FIG. 2).

The spatial decomposition is performed as follows: For a small object A, we compute the offset surface δA⁺ and define the near-object region, denoted as Ω^{N}, as the space inside the offset surface. The offset surface of an object is computed using discretized distance fields and the marching cubes algorithm similar to James et al. [14]. If the offset surfaces of two objects intersect then they are treated as a single object and are enclosed in one Ω^{N}. The space complementary to the near-object region is defined as the far-field region, and is denoted as Ω^{G}.

Geometric acoustics: The pressure waves constituting the sound field in Ω^{G} are modeled as a discrete set of rays. Their propagation in space and interaction with environment features (e.g. reflection from walls) are governed by geometric acoustic principles. We denote the pressure value defined collectively by the rays at position x as p_{G}(x),

$${p}^{G} ( x ) = {\sum }_{r ∈ R} {p}_{r} ( x ) , \qquad ( 2 )$$

where pᵣ is the contribution from one ray r in a set of rays R.

Numerical acoustic techniques: The sound pressure field scattered by objects in Ω^{N} is treated by wave-based numerical techniques for lower frequencies, in which the wave phenomena such as diffraction and interference are inherently modeled. We denote the pressure value at position x computed using numerical techniques as p^{N}(X).

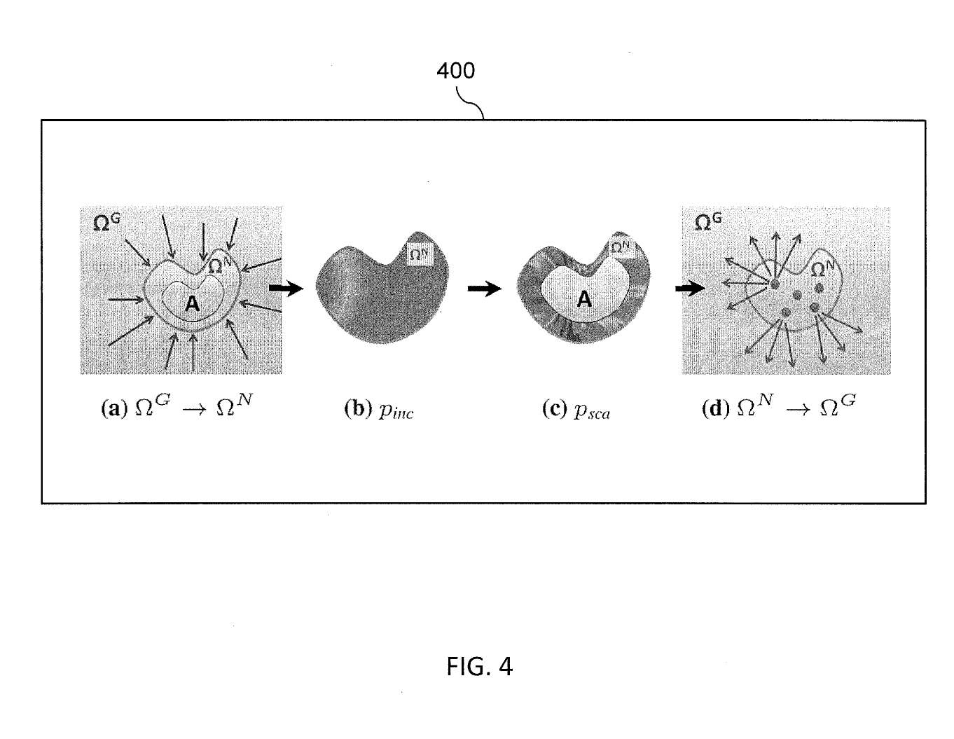

Coupling: At the interface between near-object and far-field regions, the pressures computed by the two different acoustic techniques need to be coupled (FIG. 4). Rays entering a near-object region define the incident pressure field that serves as the input to the numerical solver. Similarly, the outgoing scattered pressure field computed by the numerical solver must be converted to a set of rays. The process is detailed in Section 4.

Pressure computation: At each frequency lower than vₘₐₓ, the coupled geometric and numerical methods are used to solve the global sound pressure field. All frequencies higher than vₘₐₓ are handled by geometric techniques throughout the entire domain.

Acoustic kernel: The previous stages serve as an acoustic kernel, which computes the impulse responses (IRs) for a given source-listener position pair. For each sound source, the pressure value at each listener position is evaluated for all simulated frequencies to give a complete acoustic frequency response (FR), which can in turn be converted to an impulse response (IR) through Fourier transform. IR's for predefined source-listener positions (usually on a grid) are precomputed and stored.

Auralization: At runtime, the IR for a general listener position is obtained by interpolating the neighboring precomputed IR's [24], and the output sound is auralized by convoluting the input sound with the IRs in real time.

FIG. 4 is a diagram illustrating an exemplary two-way coupling of pressure values computed by geometric and numerical techniques according to an embodiment of the subject matter described herein. Referring to FIG. 4, at step (a), rays may be collected at a boundary (e.g., an interface between near-object and far-field regions) and pressure may be evaluated.

At step (b), the pressure on the boundary may define the incident pressure field p_{inc} in Ω^{N}, which serves as the input to a numerical solver.

At step (c), the numerical solver may compute the scattered field p_{sca}, which is the effect of object A to the pressure field.

At step (d), p_{sca} may be expressed as fundamental solutions and represented as rays emitted to Ω^{G}.

### 4 Two-Way Wave-Ray Coupling

In this section, various aspects associated with an exemplary two-way coupling procedure are disclosed. The precomputation and runtime phases associated with an exemplary two-way coupling procedure are also discussed. The coupling procedure ensures the consistency between p^{G} and p^{N}, the pressures computed by the geometric and numerical acoustic techniques, respectively. Any exchange of information at the interface between Ω^{G} and Ω^{N} must result in valid solutions to the Helmholtz equation (1) in both domains Ω^{G} and Ω^{N}.

### 4.1 Geometric→Numerical

From the pressure field p^{G}, we want to find the incident pressure field p_{inc}, which serves as the input to the numerical solver inside Ω^{N}. The incident pressure field is defined as the pressure field that corresponds to the solution of the wave equation if there were no objects in Ω^{N}.

Mathematically p_{inc} is the solution of the free-space Helmholtz Equation (1) with forcing term f=0. Since there is no object in domain Ω^{G},

p_{inc}(x)=p^{G}(x); xεΩ^{G}. (3)

This equation defines a Dirichlet boundary condition on the interface δA⁺:

p=p^{G}(x); xε∂A⁺, (4)

The uniqueness of the acoustic boundary value problem guarantees that the solution of the free-space Helmholtz Equation, along with the specified boundary condition, is unique inside Ω^{N}. The unique solution p_{inc}(x) can be found by expressing it as a linear combination of fundamental solutions. For example, A fundamental solution F for a linear operator L (in this case the Helmholtz operator

$$L = {∇}^{2} + \frac{{ω}^{2}}{{c}^{2}} )$$

is defined as the solution to the equation LF=δ(x), where δ is the Dirac delta function [31]. If φᵢ(x) is a fundamental solution, and p_{inc}(x) is expressed as a linear combination,

$${p}_{inc} ( x ) = {\sum }_{i} {c}_{i} {ϕ}_{i} ( x ) x ∈ {Ω}^{N} , \qquad ( 5 )$$

then the linearity of the wave equation implies that p_{inc}(x) is also a solution. Furthermore, if the coefficients cᵢ are such that the boundary condition (4) is satisfied, then p_{inc}(x) is the required unique solution to the boundary value problem (Section 3 in Ochmann [21]). Therefore, the resultant pressure field is a valid incoming field in the numerical domain. The numerical solver takes the incident pressure field, considers the effect of the object inside Ω^{N}, and computes the outgoing scattered field. FIGS. 4(a) and 4(b) illustrate the process.

### 4.2 Numerical→Geometric

In order to transfer information from Ω^{N} to Ω^{G}, a discrete set of rays must be determined to represent the computed pressure p^{N}. These outgoing rays may be emitted from some starting points located in Ω^{N} and carry different information related to the modeled pressure waves (strength, phase, frequency, spatial derivatives of pressure, etc.) The coupling procedure thus needs to compute the appropriate outgoing rays, given the numerically computed p^{N}.

The scattered field in the numerical domain due to the object can be simply written as,

p_{sca}(x)=p^{N}(x); xεΩ^{N}. (6)

We need to find the scattered field outside of Ω^{N}, and model it as a set of rays. As before, Equation (6) defines a Dirichlet boundary condition on the interface δA⁺,

p=p^{N}(x); xε∂A⁺. (7)

The free space Helmholtz Equation, along with this boundary condition, uniquely defines the scattered field p_{sca} outside Ω^{N}. We again express p_{sca} as a linear combination of fundamental solutions φⱼ:

$${p}_{sca} ( x ) = {\sum }_{j} {c}_{j} {ϕ}_{j} ( x ) ; x ∈ {Ω}^{G} , \qquad ( 8 )$$

and then find the coefficients cⱼ by satisfying the boundary condition (7). This gives us a unique solution for scattered field p_{sca}(x) outside Ω^{N}. We then use a set of rays Rⱼ^{out} to model the fundamental solutions φⱼ(x) such that

$${ϕ}_{j} ( x ) = {\sum }_{r ∈ {R}_{j}^{out}} {p}_{r} ( x ) , x ∈ {Ω}^{G} . \qquad ( 9 )$$

These rays correctly represent the outgoing scattered field in Ω^{G}. FIGS. 4(c) and 4(d) illustrate the process.

The coupling process described above is a general formulation and is independent of the underlying numerical solver (BEM, FEM, etc.) that is used to compute p^{N} as long as the pressure on the interface ∂A⁺ can be evaluated and expressed as a set of fundamental solutions. Depending on the mathematical formulation of the selected set of fundamental solutions φⱼ(x), different rays (starting points, directions, information carried, etc.) can be defined. However, a general principle is that if φⱼ(x) has a singularity at yⱼ, then yⱼ is a natural starting point from which rays are emitted. The directions of rays sample a unit sphere uniformly or with some distribution function (e.g. guided sampling [27]). The choice of fundamental solutions will be discussed in the next section.

Note that if the fundamental solutions φᵢ and φⱼ used to express the incident field (Equation (5)) and outgoing scattered field (Equation (8)) are predetermined, then the mapping from φᵢ to φⱼ can be precomputed. This precomputation process will be discussed in section 4.4.

### 4.3 Fundamental Solutions

The requirement for the choice of fundamental solution φⱼ is that it must satisfy the Helmholtz Equation (1) and the Sommerfeld radiation condition.

Equivalent Sources:

One choice of fundamental solutions is based on equivalent sources [21]. Each fundamental solution is chosen to correspond to the field due to multipole sources of order L (L=1 is a monopole, L=2 is a dipole, etc.) located at yⱼ:

φⱼ(x)=φⱼₗₘ(x), (10)

for l≦L−1 and −l≦m≦l, and

φⱼₗₘ=Γₗₘhₗ⁽²⁾(ωρⱼ/c)ψₗₘ(θⱼ,φⱼ), (11)

where (ρⱼ,θⱼ,φⱼ) corresponds to the vector (x−yⱼ) expressed in spherical coordinates, hₗ⁽²⁾(•) is the complex-valued spherical Hankel function of the second kind, ψₗₘ(θⱼ,φⱼ) is the complex-valued spherical harmonic function, and Γₗₘ is the real-valued normalizing factor that makes the spherical harmonics orthonormal [3]. We use a shorthand generalized index h for (l,m), such that φⱼₕ(x)≡φⱼₗₘ(x).

For pressure fields outside of θA⁺ (i.e. in Ω^{G}), these equivalent sources are placed inside of ∂A⁺ (i.e. in Ω^{N}). In a similar fashion, for pressure fields inside Ω^{N}, the equivalent sources must be placed outside Ω^{N}.

We model the outgoing pressure field from these equivalent sources using rays (Equation (9)) as follows. Rays are emitted from the source location y^{j}. For a ray of direction (θ,φ) that has traveled a distance ρ, its pressure is scaled by ψₗₘ(θ,φ) and hₗ⁽²⁾(ωρ/c).

Note that we can use equivalent sources to express a pressure field independently of how the pressure field was computed. For a computed p^{N}, we only need to find the locations yⱼ and coefficients cⱼ of the equivalent sources. This is performed by satisfying the boundary condition (8) in a least squared sense.

Boundary Elements:

If the underlying numerical acoustic technique of choice is the boundary element method (BEM), then another set of fundamental solutions which is directly based on the BEM formulation is possible. For a domain with boundary ∂Ω, the boundary element method solves the boundary integral equation of the Helmholtz equation. The boundary ∂Ω is discretized into triangular surface elements, and the equation is solved numerically for two variables; the pressure p and its normal derivative

$${}_{\frac{\partial p}{\partial n}} \frac{\partial p}{\partial n}$$

on the boundary. Once the boundary solutions p and

$$\frac{\partial p}{\partial n}$$

are known, the sound pressure in the domain can be found for any point x by summing all the contributions from the surface triangles:

$$p ( x ) = {\int }_{\partial Ω}^{ } ( G ( y , x ) \frac{\partial p ( y )}{\partial n} - \frac{\partial G ( y , x )}{\partial n} p ( y ) ) d ( \partial Ω ( y ) ) , \qquad ( 12 )$$

where y is the approximated position of the triangle and G is the Green's Function G(y,x)=exp(ĵω|x−y|/c)/4π|x−y| [12].

Note that the discretization of Equation (12) also takes the form of Equation (8) as a linear combination of fundamental solutions:

$$p ( x ) = {\sum }_{j} ( {c}_{j}^{1} {ϕ}_{j}^{1} ( x ) + {c}_{j}^{2} {ϕ}_{j}^{2} ( x ) ) , \qquad ( 13 )$$

where the two kinds of fundamental solutions are

$${ϕ}_{j}^{1} ( x ) = G ( {y}_{j} , x ) \frac{\partial p ( {y}_{j} )}{\partial n} ; \\ {ϕ}_{j}^{2} ( x ) = - \frac{\partial G ( {y}_{j} , x )}{\partial n} p ( {y}_{j} ) . \qquad ( 14 )$$

Under this formulation, we can represent the pressure field as two kinds of rays emitted from each triangle location yⱼ, each modeling φⱼ¹(x) and φⱼ²(x) respectively. Then for a point in Ω^{G} the pressure field defined by the rays is computed according to Equation (12).

### 4.4 Precomputed Transfer Functions

If we consider what happens in Ω^{N} as a black box, the net result of the coupling and the numerical solver is that a set of rays enter Ω^{N} and then another set of rays exit Ω^{N}:

$${R}^{in} {}^{M} {R}^{out} , \qquad ( 15 )$$

where Rⁱⁿ is the set of incoming rays entering Ω^{N}, R^{out} is the set of outgoing rays, and M is the ray transfer function. In this case, the function M is similar to the bidirectional reflectance distribution function (BRDF) for light [5]. In an exemplary formulation, M encodes all the operations for the following computations:
1. Collect pressures defined by Rⁱⁿ to form the incident field on the interface (Equation (4));
2. Express the incident field as a set of fundamental solutions (Equation (5));
3. Compute the outgoing scattered field using the numerical acoustic technique;
4. Express the outgoing scattered field as a set of fundamental solutions (Equation (8)); and finally,
5. Find a set of rays R^{out} that model these functions (Equation (9)).

A straightforward realization of hybrid sound propagation technique is possible: from each sound source rays are traced, interacting with the environment features, entering and exiting the near-object regions transferred by different M's, and finally reaching a listener. However, as the first step of Mdepends on the incoming rays Rⁱⁿ, a different M must be computed each time the rays enter the same near-object region. Moreover, the process must be repeated until the solution converges to a steady state, which may be too time-consuming for a scene (e.g. an indoor scene) with multiple ray reflections causing multiple entrances to near-object regions.

We avoid this problem by observing that if the fundamental solutions in Step 2 (denoted as φᵢⁱⁿ) and Step 4 (denoted as φⱼ^{out}) are predefined, then we can precompute the results of Step 2-Step 5 for an object. Similar to the BRDF for light, one can define the BRDF for sound. The mapping of φᵢⁱⁿ to φⱼ^{out} for an object is called the per-object transfer function. For different Rⁱⁿ that define an incident field p_{inc} on the interface, we only need to compute the expansion coefficients dᵢ of the fundamental solutions φᵢⁱⁿ; the outgoing rays are computed by applying the precomputed per-object transfer function.

The outgoing scattered field that is modeled as outgoing rays from an object A may, after propagating in space and interacting with the environment, enter as incoming rays into the near-object region of another object B. For a scene where the environment and relative positions of various objects are fixed, we can precompute all the propagation paths for rays that correspond to A's outgoing basis functions φ_{j,A}^{out} and that reach B's near-object region. These rays determine the incident pressure field arriving at object B, which can again be expressed as a linear combination of a set of basis functions φ_{i,B}ⁱⁿ. The mapping from φ_{j,A}^{out} to φ_{i,B}ⁱⁿ, called the inter-object transfer function, which is a fixed function and can also be precomputed. Interactions between multiple objects can therefore be found by a series of applications of the inter-object transfer functions.

Based on the per-object and inter-object transfer functions, all orders of acoustic interaction (corresponding to multiple entrance of rays to near-object regions) in the scene can be found for the total sound field by solving a global linear system, which is much faster than the straightforward hybridization, where the underlying numerical solver is invoked multiple times for each order of interactions. The trade-off is that the transfer functions have to be precomputed. However, the pre-object transfer functions can be reused even when the objects are moved. This characteristic is beneficial for quick iterations when authoring scenes, and can potentially be a cornerstone for developing sound propagation systems that supports fully dynamic scenes.

TABLE 1
Precomputation Performance Statistics

| Hybrid Pressure Solving | | | | | | | | | | | | |
|---|---|---|---|---|---|---|---|---|---|---|---|---|
| | | | | Numerical | | | | Geometric | | | | |
| | | | #eq. | | per- | inter- | source + | | | | Propagation | Pressure |
| Scene | #src | #freq. | srcs | wave sim. | object | object | global field | #tris | order | #rays | time | Evaluation |
| Building + small | 1 | 300 | 220K | 163 min | 552 min | 22 min | 19 min | 60 | 3 | 4096 | 41 min | 81 sec |
| Building + medium | 1 | 400 | 290K | 217 min | 736 min | 33 min | 23 min | 60 | 3 | 4096 | 39 min | 81 sec |
| Building + large | 1 | 800 | 580K | 435 min | 1472 min | 54 min | 40 min | 60 | 3 | 4096 | 39 min | 81 sec |
| Reservoir | 1 | 500 | 500K | 254 min | 252 min | 4 min | 2.6 min | 16505 | 2 | 262144 | 1.9 min | 10 sec |
| Parking | 2 | 500 | 123K | 55 min | 40 min | 3 min | 0.9 min | 5786 | 2 | 4096 | 6.6 min | 24 sec |

In Table 1, the rows “Building+small”, “Building+medium”, and “Building+large” correspond to scenes with a building surrounded by small, medium, and large walls, respectively. “Reservoir” and “Parking” denote the reservoir and underground parking garage scene respectively. For a scene, “#src” denotes the number of sound sources in the scene, “#freq.” is the number of frequency samples, and “#eq. srcs” denotes the number of equivalent sources. The first part, “Hybrid Pressure Solving”. includes all the steps required to compute the final equivalent source strengths, and is performed once for a given sound source and scene geometries. The second part, “Pressure Evaluation”, corresponds to the cost of evaluating the contributions from all equivalent sources at a listener position and is performed once for each listener position. For the numerical technique, “wave sim.” refers the total simulation time of the numerical wave solver for all frequencies; “per-object” denotes the computation time of for per-object transfer functions; “inter-object” is the inter-object transfer functions for each pair of objects (including self-inter-object transfer functions, where the pressure wave leaves a near-object region and reflected back to the same object); “source+global solve” is the time to solve the linear system to determine the strengths of incoming and outgoing equivalent sources. For the geometric technique, “# tris” is the number of triangles in the scene; “order” denotes the order of reflections modeled; “# rays” is the number of rays emitted from a source (sound source or equivalent source). The column “propagation time” includes the time of finding valid propagation paths and computing pressures for any intermediate step (e.g. from one object to another object's offset surface).

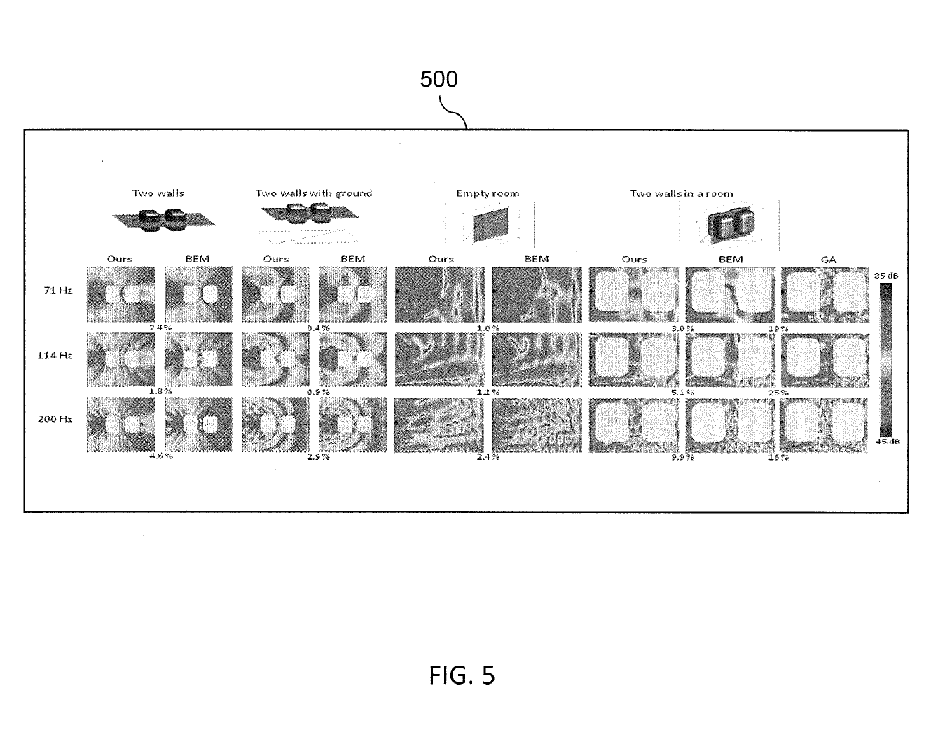

FIG. 5 is a diagram illustrating total pressure fields computed by an exemplary hybrid technique described herein and a boundary element method (BEM). Referring to FIG. 5, results of an exemplary hybrid technique described herein are compared with BEM on a spatial grid of listener locations at different frequencies for several scenes: two parallel walls, two walls with a ground, an empty room, and two walls in a room. In the top row of FIG. 5, the dot represents a sound source, and the plane represents a grid of listeners. Errors between the exemplary hybrid technique and BEM for each frequency are shown in each row. With regard to the exemplary hybrid technique, the effect of the two walls is simulated by numerical acoustic techniques, and the interaction between the ground and the room is handled by geometric acoustic techniques. For BEM, the entire scene (including the walls, ground, and room) is simulated together. The last column in FIG. 5 also shows comparison with a pure geometric technique (marked as “GA”).

### 5 Implementation

In this section, details for an exemplary implementation of a hybrid sound propagation technique described herein are disclosed.

5.1 Implementation details

The geometric acoustics code is written in C++, based on the Impulsonic Acoustect SDK⁴, which implements a ray tracing based image source method. For the numerical acoustic technique we use a GPU-based implementation of the ARD wave-solver [23]. Per-object transfer functions, inter-object transfer functions, and equivalent source strengths are computed using a MATLAB implementation based on [19].

Table 1 provides the detailed timing results for the precomputation stage. The timings are divided into two groups. The first group, labeled as “Hybrid Pressure Solving,” consists of all the steps required to compute the final equivalent source strengths. These computations are performed once for a given scene. The second group, labeled as “Pressure Evaluation,” involves the computation of the pressures contributed by all equivalent sources at a listener position. This computation is performed once for each sampled listener position.

The timing results for “wave sim.” (simulation time of the ARD wave solver), and “Pressure Evaluation” are measured on a single core of a 4-core 2.80 GHz Xeon X5560 desktop with 4 GB of RAM and NVIDIA GeForce GTX 480 GPU with 1.5 GB of RAM. All the other results are measured on a cluster containing a total of 436 cores, with sixteen 16-CPUs (8 dual-core 2.8 GHz Opterons, 32 GB RAM each) and forty-five 4-CPU (2 dual-core 2.6 GHz Opterons, 8 GB RAM each).

Assuming the scene is given as a collection of objects and terrains, in the spatial decomposition step, the offset surface may be computed using distance fields. One important parameter is the spatial Nyquist distance h, corresponding to the highest frequency simulated vₘₐₓ, h=c/2vₘₐₓ, where c is the speed of sound. To ensure enough spatial sampling on the offset surface, we choose the voxel resolution of distance field to be h, and the sample points are the vertices of the surface given by the marching cubes algorithm. The offset distance is chosen to be 8h. In general, a larger offset distance means a larger spatial domain for the numerical solver and is therefore more expensive. On the other hand, a larger offset distance results in a pressure field with less detail (i.e. reduced spatial variation) on the offset surface, and fewer outgoing equivalent sources are required to achieve the same error threshold.

### 5.2 Collocated Equivalent Sources

The positions of outgoing equivalent sources can be generated by a greedy algorithm that selects the best candidate positions randomly [14]. However, if each frequency is considered independently, a total of 1M or outgoing equivalent sources may arise across all simulated frequencies. Because, in some embodiments of an exemplary hybrid framework described herein, Nᵣ rays may need to be traced, (typically thousands or more) from each equivalent source, this computation may become a major bottleneck.

This issue may be resolved by reusing equivalent sources positions across different frequencies as much as possible. First, the equivalent sources for the highest frequency vₘₐₓ, which requires the highest number of equivalent sources, Pₘₐₓ, are computed using the greedy algorithm. For lower frequencies, the candidate positions are drawn from the Pₘₐₓ existing positions, which guarantees that a total of Pₘₐₓ collocated positions is occupied. Indeed, when the path is frequency-independent, rays emitted from collocated sources will travel the same path, which reduces the overall ray tracing cost. The frequency-independent path assumption holds for paths containing only specular reflections, in which case the incident and reflected directions are determined. We observe a 60-100× speedup while maintaining the same error bounds over methods without the collocation scheme. All the timings results in this section are based on this optimization.

### 5.3 Auralization

We compute the frequency responses using an exemplary spatial decomposition approach described herein up to vₘₐₓ=1 kHz with a sampling step size of 2.04 Hz. For frequencies higher than vₘₐₓ, we use a ray tracing solution, with diffractions approximated by the Uniform Theory of Diffraction (UTD) model [16]. We join the low- and high-frequency responses in the region [800,1000] Hz using a low-pass-high-pass filter combination.

The sound sources in an exemplary system described herein are recorded audio clips. The auralization is performed using overlap-add STFT convolutions. A “dry” input audio clip is first segmented into overlapping frames, and a windowed (Blackman window) Short-Time Fourier transform (STFT) is performed. The transformed frames are multiplied by the frequency responses corresponding to the current listener position. The resulting frequency-domain frames are then transformed back to time-domain frames using inverse FFT, and the final audio is obtained by overlap-adding the frames. For spatialization we use a simplified spherical head model with one listener position for each ear. Richer spatialization can be modeled using head related transfer functions (HRTFs), which are easily integrated in an exemplary technique described herein.

For the interactive auralization we implemented a simplified version of the system proposed by Raghuvanshi et al. [24]. Only the listener positions are sampled on a grid (of 0.5 m-1 m grid size), and the sound sources are kept static. The case of moving sound sources and a static listener is handled using the principle of acoustic reciprocity [22]. The interactive auralization is demonstrated through integration with Valve's Source™ game engine. Audio processing is performed using FMOD at a sampling rate of 44.1 kHz; the audio buffer length is 4096 samples, and the FFTs are computed using the Intel MKL library. The runtime performance statistics are summarized in Table 2. The parking garage scene is rendered off-line and not included in this table.

TABLE 2
Runtime Performance on a Single Core

| Scene | #IR samples | Memory | Time |
|---|---|---|---|
| Building + small | 960 | 19 MB | 3.5 ms |
| Building + med | 1600 | 32 MB | 3.5 ms |
| Building + large | 6400 | 128 MB | 3.5 ms |
| Reservoir | 17600 | 352 MB | 1.8 ms |

In Table 2, for each scene, “#IR samples” denotes the number of IR's sampled in the scene to support moving listeners or sources; “Memory” shows the memory to store the IR's; “Time” is the total running time needed to process and render each audio buffer.

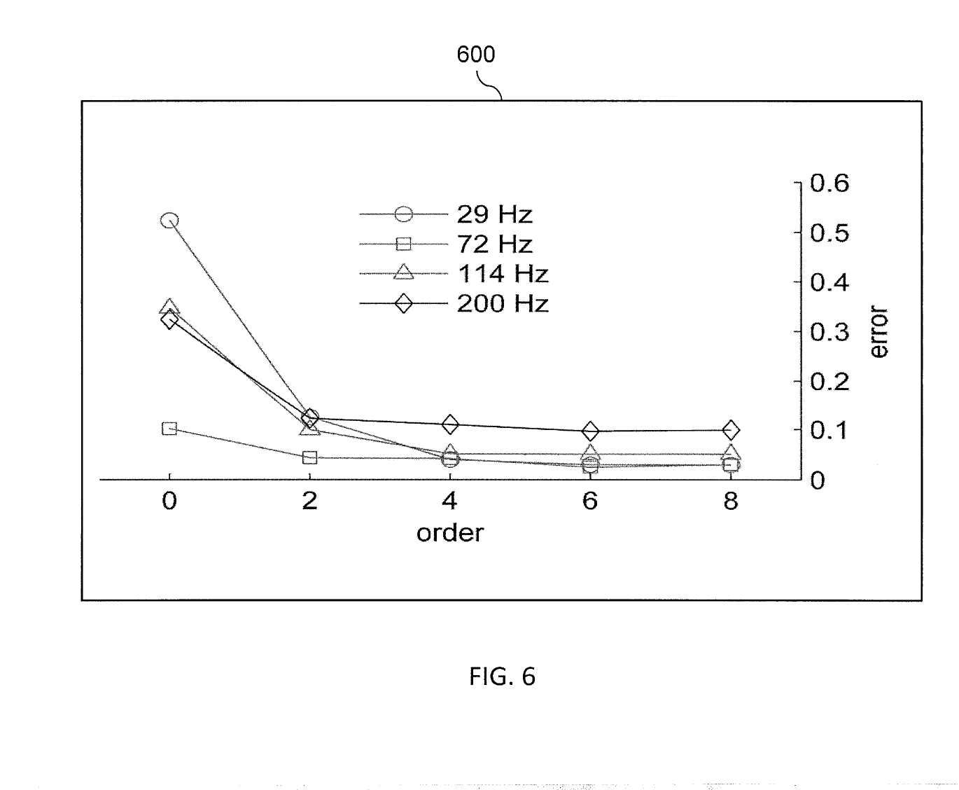

FIG. 6 includes a graph illustrating errors associated with order of reflections modeled. Referring to FIG. 6, each line represents the error at different frequencies for varying order of reflections. The error in FIG. 6 is calculated using the formular: ∥P_{ref}−P_{hybrid}∥²/∥P_{ref}, where reference wave solver is BEM. In FIG. 6, the tested scene is the “Two walls in a room” (see also FIG. 5, last column). FIG. 6 show that error significantly decreases between 0 and 2 order of reflections and stays around 0.1 error between 2 and 8 order of reflection.

### 6 Results and Analysis

In this section, results and analysis of associated with aspects of embodiments of a exemplary hybrid technique described herein are disclosed for different scenarios.

### 6.1 Scenarios

The effectiveness of an exemplary hybrid technique described herein may be demonstrated in a variety of scenes. The scenes are at least as complex as those shown in previous wave-based sound simulation techniques [14; 23; 19] or geometric methods with precomputed high-order reverberation [29; 1]. In each scene, the audio generated by the exemplary hybrid technique is compared with existing sound propagation methods: a pure geometric technique is used for comparison [27], which models specular reflection as well as edge diffraction through UTD; a pure numerical technique, the ARD wave-solver [23]. Comparisons with ARD are done only in a limited selection of scenes (Building), while the other scenes (Underground Parking Garage and Reservoir) are too large to fit in the memory using ARD.

Building.

As the listener walks behind the building, we observe the low-pass occlusion effect with smooth transition as a result of diffraction. We also observe the reflection effects due to the surrounding walls. We show how sound changes as the distance from the listener to the walls and the height of the walls vary.

Underground Parking Garage.

This is a large indoor scene with two sound sources, a human and a car, as well as vehicles that scatter and diffract sound. As the listener walks through the scene, we observe the characteristic reverberation of a parking garage, as well as the variation of sound received from various sources depending on whether the listener is in the line-of-sight of the sources.

Reservoir.

An exemplary hybrid system described herein is demonstrated in a large outdoor scene from the game Half-Life 2, with a helicopter as the sound source. This scene shows diffraction and scattering due to a rock; it also shows high-order interactions between the scattered pressure and the surrounding terrain, which is most pronounced when the user walks through a passage between the rock and the terrain. Interactive auralization is achieved by precomputing the IRs at a grid of predefined listener positions. We also make the helicopter fly and thereby demonstrate the ability to handle moving sound sources and high-order diffractions.

### 6.2 Error Analysis

In FIG. 5, the results of an exemplary hybrid technique described herein is compared with BEM on a spatial grid of listener locations at different frequencies for several scenes: two parallel walls, two walls with a ground, an empty room, and two walls in a room. BEM is one of the most accurate wave-based simulators available, and comparing with high-accuracy simulated data is a widely adopted practice [4; 15; 13]. BEM results are generated by the FastBEM simulator. A comparison with a geometric technique for the last scene is also provided. The geometric technique models 8 orders of reflection and 2 orders of diffraction through UTD.

The difference in pressure field (i.e. the error) between an exemplary hybrid technique described herein with varying reflection orders and BEM are also computed, as shown in FIG. 6 for the “Two Walls in a Room” scene. The error between the pressure fields generated by the reference wave solver and by an exemplary hybrid technique described herein, is computed as ∥P_{ref}−P_{hybrid}∥²/∥P_{ref}∥, where P_{ref} and P_{hybrid} are vectors consisting of complex pressure values at all the listener positions and ∥•∥ denotes the two-norm of complex values, summed over all positions x (the grid of listeners as shown in FIG. 4). Higher reflection orders lead to more accurate results but require more rays to be traced.

### 6.3 Complexity

Consider a scene with κ objects. We perform the complexity analysis for frequency v and discuss the cost of numerical and geometric techniques used.

Numerical Simulation and Pre-Processing: The pre-processing involves several steps: (1) performing the wave simulation using numerical techniques, (2) computing per-object and inter-object transform matrix, and (3) solving linear systems to determine the strengths of incoming and outgoing equivalent sources [19]. In an exemplary system described herein, the equivalent sources are limited to monopoles and dipoles, and the complexity follows:

O(κnQP²+κ²nPQ²+κ(u log u)+κ³P³), (16)

where Q, P are the number of incoming and outgoing equivalent sources respectively, n is the number of offset surface samples, and u is the volume of an object. The number of equivalent sources P and Q scale quadratically with frequency.

Ray Tracing:

Assume the scene has T triangles, and from each source we trace Nᵣ rays to the scene. The cost for one bounce of tracing from a source is O(Nᵣ log T) on average and O(NᵣT) in the worst case. If the order of reflections modeled is d, then the (worst case) cost of ray tracing is O(NᵣT^{d}). This cost is multiplied by the number of sources (sound sources and equivalent sources) and the number of points where the pressure values need to be evaluated. The total cost is dominated by computing inter-object transfer functions, where the pressure from P outgoing equivalent sources from an object needs to be evaluated at n sample positions on the offset surface of another object. This results in

O(κ²PnT^{d}) (17)

for a total of κ² pairs of objects in the scene.

In an exemplary collocated equivalent source scheme described herein, however, the P outgoing sources for different frequencies share a total of P_{col} positions. The rays traced from a shared position can be reused, so for all frequencies v, we only need to trace rays from P_{col} positions instead of ΣᵥP(v) positions.

The choice of Nᵣ is scene-dependent. In theory, in order to discover all possible reflections from all scene triangles without missing a propagation path, the ray density along every direction should be high enough so that the triangle spanning the smallest solid angle viewed from the source can be hit by at least one ray. The problem of missing propagation paths is intrinsic to all ray tracing methods. It can be overcome by using beam-tracing methods [8], but they are considerably more expensive and are only practical for simple scenes.

The order of reflection d also depends on the scene configuration. For an outdoor scene where most reflections come from the ground, a few reflections are sufficient. In enclosed or semi-enclosed spaces more reflections are needed. In practice it is common to stop tracing rays when a given bound of reflection is reached, or when the reflected energy is less than a threshold.

Scalability

Although the computation domain of the numerical solver, Ω^{N}, is smaller than the entire scene, the size of the entire scene still matters. Larger scenes require longer IR responses and therefore more frequency samples, which affect the cost of both numerical and geometric components of an exemplary hybrid approach described herein. Larger scenes in general require more triangles, assuming the terrain has the same feature density. For a scene whose longest dimension is L, the number of IR samples (and therefore frequency samples) scales as O(L), and the number of triangles scales as O(L²),—giving overall numerical and ray tracing complexities of—O(L) and O(L³ log L) respectively. This is better than most numerical methods; for example, the time complexity of ARD are O(L⁴ log L) and FDTD scale O(L⁴).

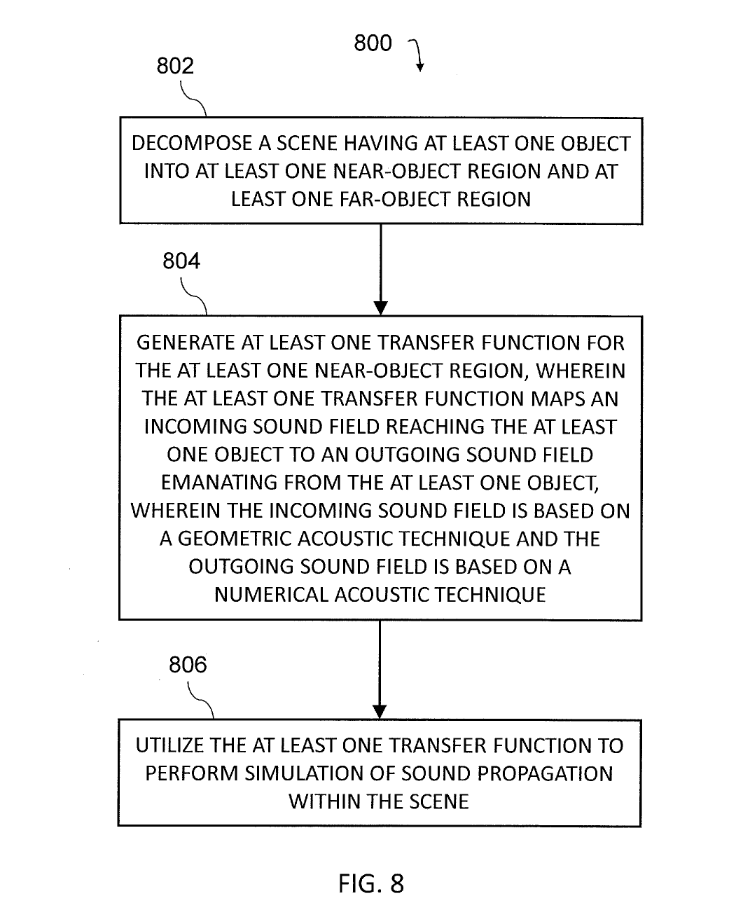

The scalability of an exemplary hybrid technique described herein was tested with the building scene by increasing the size of the scene and measuring the performance. The results are shown in FIG. 8. Since the open space is handled by geometric methods, whose complexity of the geometric method is not a direct function of the total volume, it is not necessary to divide the open space into several connected smaller domains, as some previous methods did [23].

6.4 Comparison with Prior Techniques

Compared with geometric techniques, an exemplary technique described herein is able to capture wave effects such as scattering and high-order diffraction, thereby generate sound of higher quality. When compared with performing numerical wave-based techniques such as ARD and BEM, over the entire domain, an exemplary technique described herein is much faster as we use a numerical solver only in near-object regions, as opposed to the entire volume. We do not have a parallel BEM implementation, but extrapolating from the data in FIG. 6, FastBEM would take 100+ hours for Underground Parking Garage and 1000+ hours for Reservoir on a 500-core cluster to simulate sound up to 1 kHz, assuming full parallelization. In comparison, an exemplary hybrid technique described herein can perform all (numeric, geometric, and coupling) precomputations in a few hours for these two scenes (as shown in Table 1) to achieve interactive runtime performance (see Table 2). Moreover, numerical techniques typically require memory proportional to the third or fourth power of frequency to evaluate pressures and compute l's at different listener positions. As shown in Table 3, an exemplary hybrid technique described herein requires orders of magnitude less memory than several standard numerical techniques. Also, the relative benefits of exemplary two-way coupling algorithms described herein are presented with other hybrid methods used in acoustic and electromagnetic simulation (see Section 2.3). In many ways, an exemplary coupling algorithm described herein ensures continuity and consistency of the field computed by numeric and geometric techniques at the artificial boundary between their computational domains.

The method proposed by Mehra et al. [19] is also able to simulate the acoustic effects of objects in large outdoor scenes. Their formulation, however, only allows objects to be situated in an empty space or on an infinite flat ground, and therefore cannot model large indoor scenes (e.g. parking lot) or outdoor scenes with uneven terrains. If an outdoor scene has a large object, the algorithm proposed in [19] would slow down considerably. The coupling with geometric propagation algorithm, on the other hand, enables us to model acoustic interactions with all kinds of environment features. It is relatively easier to extend an exemplary hybrid technique described herein to inhomogeneous environments by using curved ray tracing. Furthermore, geometric ray tracing is also used to perform frequency decomposition and this results in improved sound rendering.

TABLE 3
Memory Cost Saving

| | | surf. | | | | |
|---|---|---|---|---|---|---|
| | air vol. | area | | | BEM/ | HY- |
| Scene | (m³) | (m²) | FDTD | ARD | FMM | BRID |
| Bldg + | 1800 | 660 | 0.2 TB | 5 GB | 6 GB | 12 MB |
| small | | | | | | |
| Bldg + | 3200 | 1040 | 0.3 TB | 9 GB | 9 GB | 12 MB |
| med | | | | | | |
| Bldg + | 22400 | 3840 | 2.2 TB | 60 GB | 34 GB | 12 MB |
| large | | | | | | |
| Reservoir | 5832000 | 32400 | 578 TB | 16 TB | 307 GB | 42 MB |
| Parking | 9000 | 2010 | 0.9 TB | 24 GB | 2 GB | 9 MB |

In table 3, the memory required to evaluate pressures at a given point of space is presented. This corresponds to the same operation shown in the rightmost column of Table 1. Compared to standard numerical techniques, an exemplary hybrid technique described herein provides 3 to 7 orders of magnitude of memory saving on the benchmark scenes.

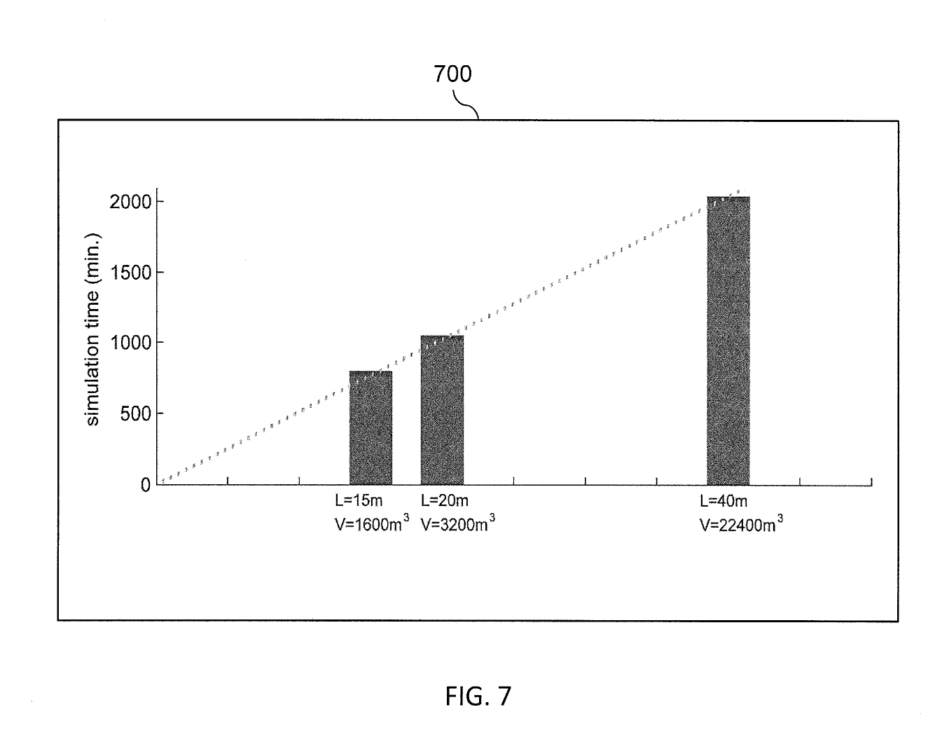

FIG. 7 includes a graph illustrating precomputation time associated with terrains of different volumes. Referring to FIG. 7, for a building placed in terrains of increasing volumes (small, medium, and large walls), the lighter gray part of each bar line indicates the simulation time for the numerical method, and the darker gray part of each bar line indicates the simulation time for the geometric method. In FIG. 7, the numerical simulation time scales linearly to the largest dimension (L) of the scene instead of the total volume (V).

7 Conclusion and Future Work Various aspects and embodiments associated with a novel hybrid technique for sound propagation in large indoor and outdoor scenes are described herein. Aspects of an exemplary hybrid technique described herein combine the strengths of numerical and geometric acoustic techniques for the different parts of the domain: the more accurate and costly numerical technique may be used to model wave phenomena in near-object regions, while the more efficient geometric technique may be used to handle propagation in far-field regions and interaction with the environment. The sound pressure field generated by the two techniques may be coupled using a novel two-way coupling procedure. An exemplary hybrid technique may be successfully applied to different scenarios to generate realistic acoustic effects.

In some embodiments, an exemplary hybrid system described herein may utilize a geometric technique that assumes a homogeneous medium and traces straight ray paths (e.g., linear ray tracing). However, in the case of inhomogeneous medium, where the speed of sound is not constant and the rays may travel in curved paths, a nonlinear ray tracing module can be integrated into an exemplary hybrid system described herein.

The performance of an exemplary spatial decomposition may depend greatly on the size of Ω^{N}. Although it size is smaller than the entire simulation domain, an individual Ω^{N} may still be too large, especially when the wave effects near a large object need to be computed and this may increase the complexity of an exemplary hybrid technique described herein. One interesting topic to investigate is the possibility of not enclosing the whole object, but only parts of it (e.g. small features) in Ω^{N}.

Simulation results have been compared with simulated data from a high-accuracy BEM solver. When accurate measurements with binaural sound recordings and spatial sampling in complex environments are available, validation and/or comparisons may be performed with recorded audio measurements.

In some embodiments, an exemplary hybrid technique and system implementation may be limited to mostly static scenes with moving sound sources and/or listeners. In some embodiments, the use of transfer functions may be usable to simulate sound propagation in fully dynamic scenes, as the per-object transfer functions of an object can be reused even when the object is moved. In order to recompute inter-object transfers as multiple objects move in a dynamic scene, a large number of rays (the number of outgoing sources for all frequency samples multiplied by thousands of rays emitted per source) may need to be retraced.

In some embodiments, a Fast Multipole Method (FMM) [11] may be used to reduce the number of outgoing sources for far-field approximations. In some embodiments, computations of transfer functions may be implemented using a variety of programming languages, including MATLAB code or high-performance linear solvers (CPU- or GPU-based), and/or computing platforms or devices.

FIG. 8 is a diagram illustrating an exemplary process 800 for simulating sound propagation according to an embodiment of the subject matter described herein. Some embodiments, exemplary process 800, or portions thereof, may be performed by or at SPM 110, processor core(s) 108, node 102, and/or another node or module.

At step 802, a scene having at least one object into at least one near-object region and at least one far-object region may be decomposed.

At step 804, at least one transfer function for the at least one near-object region may be generated. The at least one transfer function may map an incoming sound field reaching the at least one object to an outgoing sound field emanating from the at least one object. The incoming sound field may be based on a geometric acoustic technique (e.g., a ray tracing technique) and the outgoing sound field may be based on a numerical acoustic technique (e.g., a boundary element method).

In some embodiments, generating at least one transfer function for at least one near-object region may include generating at least one transfer function prior to simulating sound propagation in the scene or executing a sound propagation model.

In some embodiments, generating at least one transfer function for at least one near-object region may include collecting pressures defined by one or more incoming rays to form an incident field on an interface between the near-object region and the far-object region, expressing an incident field as a first set of fundamental solutions, computing an outgoing scattered field using a numerical acoustic technique and the first set of fundamental solutions, expressing an outgoing scattered field as a second set of fundamental solutions, and determining one or more outgoing rays using the second set of fundamental solutions.

In some embodiments, at least one transfer function may include at least one of an inter-object transfer function and a per-object transfer function.

In some embodiments, at least one transfer function may be utilized multiple times in simulating sound propagation in a scene or virtual environment.

In some embodiments, a near-object region may include a region near an object, wherein the object's size is comparable to or smaller than a wavelength of a sound wave.

In some embodiments, a far-object region may include a region having no objects or having objects whose sizes are larger than a wavelength of a sound wave.

In some embodiments, at least one transfer function may map an incoming sound field reaching at least one object to an outgoing sound field after accounting for sound propagation effects such as reflection, scattering, or diffraction due to the at least one object.

In some embodiments, incoming and outgoing sound fields associated with a transfer function may be expressed using rays or geometric acoustic information.

In some embodiments, an inter-object transfer function may map an outgoing sound field of at least one object to an incoming sound field of another object.

In some embodiments, at least one transfer function corresponding to at least one object within the scene may be stored for future use in simulating a second scene that includes the at least one object.

In some embodiments, at least one transfer function may represent converting a sound pressure computed using a numerical acoustic technique into input usable by a geometric acoustic technique and converting a pressure computed using the geometric acoustic technique into input usable by the numerical acoustic technique.

At step 804, the at least one transfer function may be utilized to perform simulation of sound propagation within the scene.

In some embodiments, utilizing at least one transfer function to perform simulation of sound propagation within the scene may include utilizing a geometric acoustic technique for a far-object region.

In some embodiments, utilizing at least one transfer function may include using the at least one transfer function in solving a global linear system for computing all orders of interaction.

### REFERENCES

The disclosures of all of the references listed herein are hereby incorporated herein by reference in their entireties.
[1] Antani, L., Chandak, A., Savioja, L., and Manocha, D. 2012. Interactive sound propagation using compact acoustic transfer operators. ACM Trans. Graph. 31, 1 (February), 7:1-7:12.
[2] Aretz, M. 2012. Combined wave and ray based room acoustic simulations of small rooms: challenges and limitations on the way to realistic simulation results. PhD thesis, Aachener Beitrge zur Technischen Akustik.
[3] Arfken, G. B., Weber, H. J., and Ruby, L. 1985. Mathematical methods for physicists, vol. 3. Academic press San Diego.
[4] Barbone, P. E., Montgomery, J. M., Michael, O., and Harari, I. 1998. Scattering by a hybrid asymptotic/finite element method. Computer methods in applied mechanics and engineering 164, 1, 141-156.
[5] Ben-Artzi, A., Egan, K., Durand, F., and Ramamoorthi, R. 2008. A precomputed polynomial representation for interactive BRDF editing with global illumination. ACM Transactions on Graphics (TOG) 27, 2, 13.
[6] Blauert, J. 1983. Spatial hearing: The psychophysics of human sound localization. MIT Press (Cambridge, Mass.).
[7] Botteldooren, D. 1994. Acoustical finite-difference time-domain simulation in a quasi-Cartesian grid. The Journal of the Acoustical Society of America 95, 2313.
[8] Funkhouser, T., Carlbom, I., Elko, G., Pingali, G., Sondhi, M., and West, J. 1998. A beam tracing approach to acoustic modeling for interactive virtual environments. In Proc. SIGGRAPH 1998, 21-32.
[9] Funkhouser, T., Tsingos, N., and Jot, J.-M. 2004. Survey of methods for modeling sound propagation in interactive virtual environment systems. Presence.
[10] Granier, E., Kleiner, M., Dalenbck, B.-I., and Svensson, P. 1996. Experimental auralization of car audio installations. Journal of the Audio Engineering Society 44, 10, 835-849.
[11] Gumerov, N. A., and Duraiswami, R. 2004. Fast multipole methods for the Helmholtz equation in three dimensions. Elsevier Science.
[12] Gumerov, N. A., and Duraiswami, R. 2009. A broadband fast multipole accelerated boundary element method for the three-dimensional helmholtz equation. J. Acoustical Society of America 125, 1, 191-205.
[13] Hampel, S., Langer, S., and Cisilino, A. P. 2008. Coupling boundary elements to a raytracing procedure. International journal for numerical methods in engineering 73, 3, 427-445.
[14] James, D. L., Barbic, J., and Pai, D. K. 2006. Precomputed acoustic transfer: output-sensitive, accurate sound generation for geometrically complex vibration sources. In Proc. of ACM SIGGRAPH, 987-995.
[15] Jean, P., Noe, N., and Gaudaire, F. 2008. Calculation of tyre noise radiation with a mixed approach. Acta Acustica united with Acustica 94, 1, 91-103.
[16] Kouyoumjian, R. G., and Pathak, P. H. 1974. A uniform geometrical theory of diffraction for an edge in a perfectly conducting surface. Proc. of IEEE 62 (November), 1448-1461.
[17] Lentz, T., Schroeder, D., Vorlander, M., and Assenmacher, I. 2007. Virtual reality system with integrated sound field simulation and reproduction. EURASIP J. Applied Signal Processing.
[18] Lokki, T., Southern, A., Siltanen, S., and Savioja, L. 2011. Studies of epidaurus with a hybrid room acoustics modeling method. In Acoustics of Ancient Theaters Patras, Greece.
[19] Mehra, R., Raghuvanshi, N., Antani, L., Chandak, A., Curtis, S., and Manocha, D. 2013. Wave-based sound propagation in large open scenes using an equivalent source formulation. ACM Trans. Graph. 32, 2 (April), 19:1-19:13.
[20] Murphy, D., Shelley, S., Beeson, M., Moore, A., and Southern, A. 2008. Hybrid room impulse response synthesis in digital waveguide mesh based room acoustics simulations. In Proc. of the Int. Conference on Digital Audio Effects (DAFx-08).
[21] Ochmann, M. 1995. The source simulation technique for acoustic radiation problems. Acta Acustica united with Acustica 81, 6, 512-527.
[22] Pierce, A. D. 1989. Acoustics: an introduction to its physical principles and applications. Acoustical Society of America.
[23] Raghuvanshi, N., Narain, R., and Lin, M. C. 2009. Efficient and Accurate Sound Propagation Using Adaptive Rectangular Decomposition. IEEE Transactions on Visualization and Computer Graphics 15, 5, 789-801.
[24] Raghuvanshi, N., Snyder, J., Mehra, R., Lin, M., and Govindaraju, N. 2010. Precomputed wave simualtion for real-time sound propagation of dynamic sources in complex scenes. ACM Trans. on Graphics (Proc. of ACM SIGGRAPH) 29, 3.
[25] Southern, A., Siltanen, S., and Savioja, L. 2011. Spatial room impulse responses with a hybrid modeling method. In Audio Engineering Society Convention 130.
[26] Svensson, U. P., Fred, R. I., and Vanderkooy, J. 1999. An analytic secondary source model of edge diffraction impulse responses. J. Acoustical Society of America 106, 5, 2331-2344.
[27] Taylor, M., Chandak, A., Qi Mo, Lauterbach, C., Schissler, C., and Manocha, D. 2012. Guided multiview ray tracing for fast auralization. Visualization and Computer Graphics, IEEE Transactions on 18, 11 (November), 1797-1810.
[28] Thompson, L. L. 2006. A review of finite-element methods for time-harmonic acoustics. J. Acoustical Society of America 119, 3, 1315-1330.
[29] Tsingos, N. 2009. Pre-computing geometry-based reverberation effects for games. 35th AES Conference on Audio for Games.
[30] Tsingos, N., Funkhouser, T., Ngan, A., and Carlbom, I. 2001. Modeling acoustics in virtual environments using the uniform theory of diffraction. In Proc. SIGGRAPH 2001, 545-552.
[31] Vladimirov, V. S. 1976. Generalized functions in mathematical physics. Moscow Izdatel Nauka 1.
[32] Vorlander, M. 1989. Simulation of the transient and steady-state sound propagation in rooms using a new combined ray tracing/image-source algorithm. J. Acoustical Society of America 86, 1, 172-178.
[33] Wang, Y., Safavi-Naeini, S., and Chaudhuri, S. 2000. A hybrid technique based on combining ray tracing and FDTD methods for site-specific modeling of indoor radio wave propagation. Antennas and Propagation, IEEE Transactions on 48, 5 (May), 743-754.
[34] Waterman, P. C. 2009. T-matrix methods in acoustic scattering. The Journal of the Acoustical Society of America 125, 1, 42-51.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for simulating sound propagation, the method comprising:
decomposing a scene having at least one object into at least one near-object region and at least one far-object region;
generating at least one transfer function for the at least one near-object region, wherein the at least one transfer function maps an incoming sound field reaching the at least one object to an outgoing sound field emanating from the at least one object, wherein the incoming sound field is based on a geometric acoustic technique and the outgoing sound field is based on a numerical acoustic technique; and
utilizing the at least one transfer function to perform simulation of sound propagation within the scene.

2. The method of claim 1 wherein utilizing the at least one transfer function to perform simulation of sound propagation within the scene includes utilizing the geometric acoustic technique for the far-object region.

3. The method of claim 1 wherein the at least one transfer function represents converting a sound pressure computed using the numerical acoustic technique into input usable by the geometric acoustic technique and converting a pressure computed using the geometric acoustic technique into input usable by the numerical acoustic technique.

4. The method of claim 1 wherein utilizing the at least one transfer function includes using the at least one transfer function in solving a global linear system for computing all orders of interaction.

5. The method of claim 1 wherein generating at least one transfer function for the at least one near-object region includes:
collecting pressures defined by one or more incoming rays to form an incident field on an interface between the near-object region and the far-object region;
expressing the incident field as a first set of fundamental solutions;
computing an outgoing scattered field using the numerical acoustic technique and the first set of fundamental solutions;
expressing the outgoing scattered field as a second set of fundamental solutions; and
determining one or more outgoing rays using the second set of fundamental solutions.

6. The method of claim 1 wherein generating at least one transfer function for the at least one near-object region includes generating at least one transfer function prior to simulating sound propagation in the scene or executing a sound propagation model.

7. The method of claim 1 wherein the at least one transfer function includes at least one of an inter-object transfer function and a per-object transfer function.

8. The method of claim 1 wherein the at least one transfer function is utilized multiple times.

9. The method of claim 1 wherein the at least one near-object region includes a region near the at least one object, wherein the at least one object's size is comparable to or smaller than a wavelength of a simulated sound wave.

10. The method of claim 1 wherein the far-object region includes a region having no objects or having objects whose sizes are larger than a wavelength of a simulated sound wave.

11. The method of claim 1 wherein the at least one transfer function maps the incoming sound field reaching the at least one object to the outgoing sound field after accounting for sound propagation effects such as reflection, scattering, or diffraction due to the at least one object.

12. The method of claim 1 wherein both the incoming and the outgoing sound fields are expressed using rays or geometric acoustic information.

13. The method of claim 1 wherein the inter-object transfer function maps an outgoing sound field of the at least one object to an incoming sound field of another object.

14. The method of claim 1 wherein the at least one transfer function corresponding to the at least one object within the scene is stored for future use in simulating a second scene that includes the at least one object.

15. A system for simulating sound propagation using wave-ray coupling, the system comprising:
a processor; and
a sound propagation model (SPM) module executable by the processor, the SPM module is configured to decompose a scene having at least one object into at least one near-object region and at least one far-object region; to generate at least one transfer function for the at least one near-object region, wherein the at least one transfer function maps an incoming sound field reaching the at least one object to an outgoing sound field emanating from the at least one object, wherein the incoming sound field is based on a geometric acoustic technique and the outgoing sound field is based on a numerical acoustic technique; and to utilize the at least one transfer function to perform simulation of sound propagation within the scene.

16. The system of claim 15 wherein utilizing the at least one transfer function to perform simulation of sound propagation within the scene includes utilizing the geometric acoustic technique for the far-object region.

17. The system of claim 15 wherein the at least one transfer function represents converting a sound pressure computed using the numerical acoustic technique into input usable by the geometric acoustic technique and converting a pressure computed using the geometric acoustic technique into input usable by the numerical acoustic technique.

18. The system of claim 15 wherein utilizing the at least one transfer function includes using the at least one transfer function in solving a global linear system for computing all orders of interaction.

19. The system of claim 15 wherein the SPM module is configured to generate the at least one transfer function by:
collecting pressures defined by one or more incoming rays to form an incident field on an interface between the near-object region and the far-object region;
expressing the incident field as a first set of fundamental solutions;
computing an outgoing scattered field using the numerical acoustic technique and the first set of fundamental solutions;
expressing the outgoing scattered field as a second set of fundamental solutions; and
determining one or more outgoing rays using the second set of fundamental solutions.

20. The system of claim 15 wherein the SPM module is configured to generate the at least one transfer function prior to simulating sound propagation in the scene or executing a sound propagation model.

21. The system of claim 15 wherein the at least one transfer function includes at least one of an inter-object transfer function and a per-object transfer function.

22. The system of claim 15 wherein the SPM module is configured to utilize the at least one transfer function multiple times.

23. The system of claim 15 wherein the at least one near-object region includes a region near the at least one object, wherein the at least one object's size is comparable to or smaller than a wavelength of a simulated sound wave.

24. The system of claim 15 wherein the at least one far-object region includes a region having no objects or having objects whose sizes are larger than a wavelength of a simulated sound wave.

25. The system of claim 15 wherein the at least one transfer function maps the incoming sound field reaching the at least one object to the outgoing sound field after accounting for sound propagation effects such as reflection, scattering, or diffraction due to the at least one object.

26. The system of claim 15 wherein both the incoming and the outgoing sound fields are expressed using rays or geometric acoustic information.

27. The system of claim 15 wherein the inter-object transfer function maps an outgoing sound field of the at least one object to an incoming sound field of another object.

28. The system of claim 15 wherein the at least one transfer function corresponding to the at least one object within the scene is stored for future use in simulating a second scene that includes the at least one object.

29. A non-transitory computer readable medium having stored thereon executable instructions that when executed by a processor of a computer control the computer to perform steps comprising:
decomposing a scene having at least one object into at least one near-object region and at least one far-object region;
generating at least one transfer function for the at least one near-object region, wherein the at least one transfer function maps an incoming sound field reaching the at least one object to an outgoing sound field emanating from the at least one object, wherein the incoming sound field is based on a geometric acoustic technique and the outgoing sound field is based on a numerical acoustic technique; and
utilizing the at least one transfer function to perform simulation of sound propagation within the scene.
